(19) United States
(12) Patent Application Publication
(10) Pub. No.: US 2013/0126190 A1
(43) Pub. Date: May 23, 2013

(54) ION EXCHANGE METHOD OF SWELLABLE PACKER DEPLOYMENT

(71) Applicants: Oleg A. Mazyar, Houston, TX (US); James E. Goodson, Porter, TX (US)

(72) Inventors: Oleg A. Mazyar, Houston, TX (US); James E. Goodson, Porter, TX (US)

(73) Assignee: BAKER HUGHES INCORPORATED, Houston, TX (US)

(21) Appl. No.: 13/300,916

(22) Filed: Nov. 21, 2011

(51) Int. Cl. E21B 33/127; C08J 5/20; E21B 33/12

(52) U.S. Cl. 166/387; 264/239; 521/28

(57) ABSTRACT

A downhole article includes an ion exchange polymer; and a composition that includes an elastomer and an absorbent material. A method of maintaining expandability of a downhole article includes disposing a downhole article comprising an elastomer, absorbent material, and an ion exchange material in a borehole, the ion exchange material comprising host ions; and exchanging fluid ions in a fluid with host ions from the ion exchange material to maintain the expandability of the downhole article.

### BACKGROUND

Isolation of downhole environments depends on the deployment of a downhole tool that effectively seals the entirety of the borehole or a portion thereof, for example, an annulus between a casing wall and production tube. Fixed size packers have limited use since their deployment would occur near the interface of two portions of a borehole having different inner diameters such as caused by using a smaller bit for deeper drilling after achieving a first depth with a larger drill bit. On the other hand, swellable packers can have greater utility than fixed size packers because swellable packers expand to fill the cross-sectional area of a borehole. Consequently, swellable packers can be placed in borehole locations that have a smaller inner diameter than the cross-sectional area of the fully expanded swellable packer. The initiation of such expansion can be stimulated by a condition such as a temperature change or presence of a particular fluid.

Although, swellable packers have achieved successful isolation of downhole environments, new materials and methods that contribute to the extension of the utility of swellable packers would be readily received in the art.

### BRIEF DESCRIPTION

A downhole article comprises an ion exchange polymer and a composition comprising an elastomer and an absorbent material.

A downhole article comprises a composition comprising an elastomer and an absorbent material; and an inorganic ion exchange material.

A method of manufacturing a downhole article comprises forming a composition comprising an elastomer and an absorbent material; combining ion exchange particles with the composition to produce a combination; and shaping the combination to product the downhole article.

A method of maintaining expandability of a downhole article comprises disposing a downhole article comprising an elastomer, absorbent material, and an ion exchange material in a borehole, the ion exchange material comprising host ions; and exchanging fluid ions in a fluid with host ions from the ion exchange material to maintain the expandability of the downhole article.

### BRIEF DESCRIPTION OF THE DRAWINGS

The following descriptions should not be considered limiting in any way. With reference to the accompanying drawings, like elements are numbered alike:

FIG. 1 shows a composition that includes an elastomer and an absorbent material with interposing ion exchange particles;

FIG. 2 shows a graph of percentage volume increase as a function of different salts over time for a water swelling composition contacting three different water solutions (3.5% NaCl, 3.5% ZnBr₂, and 3.5% CaCl₂) at room temperature;

FIG. 3 shows ion exchange of polyvalent fluid ions with host ions by an ion exchange material;

FIG. 4 shows a swellable composition in contact with monovalent cations after a fluid containing divalent ions traverses an ion exchange material;

FIG. 5 shows a perspective view of a downhole article that includes an elastomer, absorbent material, and ion exchange particles;

FIG. 6 shows a cross-section of a downhole article having an outer covering of ion exchange material and a central portion of an elastomer and absorbent material;

FIG. 7 shows a cross-section of a downhole article having an outer covering of ion exchange material, a central portion of an elastomer and absorbent material, and an inner diameter available to accept a tube;

FIG. 8 shows a cross-section of a downhole tool having a central support substrate or pipe that bears an ion exchange element and a sealing element (a swellable composition as described herein) in its original, non-expanded shape; and

FIG. 9 shows a cross-section of the downhole tool of FIG. 8 where the sealing element has been deployed to expand and contact the wall of a borehole into which it has been inserted or run in.

### DETAILED DESCRIPTION

A detailed description of one or more embodiments of the disclosed apparatus, method and system, are presented herein by way of exemplification and not limitation with reference to the Figures.

A downhole article includes a composition and an ion exchange material. The composition contains an elastomer and an absorbent material. Due to fluid absorption by the absorbent material, the composition expands. Upon expansion of the composition, the downhole article can expand to fill, for example, a borehole. If the downhole article expands enough, it can isolate the borehole such that fluid (for example, water or hydrocarbons) substantially does not flow past the downhole article. However, polyvalent cations that are typically used in downhole fluids can interact with the absorbent material and decrease the overall expansion of the absorbent material, hindering the sealing efficacy of the downhole article. To mitigate the deleterious effect of such polyvalent ions on the absorbent material, the ion exchange material exchanges polyvalent ions with ions from the ion exchange material that do not adversely affect the swelling of the absorbent material.

As used herein, “ion exchange” refers to adsorption of one or several ionic species accompanied by the simultaneous desorption (displacement) of an equivalent amount of one or more other ionic species. Particularly, a polyvalent ion can be exchanged by a plurality of ions having lower ionic charge as in the exchange of a divalent ion with two monovalent ions. In an embodiment, Ca²⁺ is adsorbed on an ion exchange polymer with desorption of two Na⁺ ions. As used herein, “ion exchange polymer” refers to a polymer that exchanges ions (cations or anions) with ions in a fluid. An ion exchange polymer in ionized form may also be referred to as a polyanion or a polycation. Ion exchange polymers may also be referred to as network polyelectrolytes.

In an embodiment, the ion exchange material is an ion exchange polymer, ion exchange membrane, ion exchange resin, inorganic mineral, or a combination thereof.

The organic polymer has an organic backbone. Additionally, the backbone can include non-organic components such as silicone (for example, siloxane groups (—O—Si—)) and the like. The organic polymer can be a homopolymer, random copolymer, alternating copolymer, block copolymer, or graft copolymer. Further, the organic polymer can be a linear polymer, branched polymer, or a network polymer.

According to an embodiment, the organic polymer of the ion exchange material includes a styrene polymer, phenolic polymer, acrylic polymer, methacrylic polymer, polyvinyl alcohol, carbon fiber, polyacrylamide, polyphenylene ether, polysulfone, polyester, fluorinated polymer, cellulose, agarose, dextran, or a combination thereof. The organic polymer can be crosslinked, for example, crosslinks formed from divinylbenzene or other suitable crosslinking groups.

To exchange ions the organic polymer includes a charged group. Such charged groups can be a cationic functional group, anionic functional group, or a combination thereof. When the organic polymer has both anionic and cationic functional groups, the organic polymer can be referred to as amphoteric. An organic polymer that includes a cationic functional group exchanges anions and is therefore referred to as an anion exchange polymer. Likewise, an organic polymer that includes an anionic functional group exchanges cations and is therefore referred to as a cation exchange polymer.

Although described more fully below, the charged functional group of the organic polymer is associated with a counter ion (the ion to be donated to a fluid by the ion exchange material) via, for example, ionic bonds. The initial counter ion bonded to the charged group is referred to herein as a host ion. The host ion dissociates from the charged group and is displaced by an ion from a fluid. This occurs when the ion exchange material is used in a downhole application and is in the presence of a downhole fluid, which typically contains polyvalent ions, for example, divalent and trivalent metals, in addition to certain anions.

In an embodiment, the organic polymer has an anionic functional group (i.e., the organic polymer is a cation exchange polymer) selected from a sulfonic acid group, carboxyl group, phenol group, phosphoric acid group, phosphorous acid group, phosphinic acid group, or a combination thereof. Examples of the organic polymer with anionic functional groups include polystyrene sulfonic acid, polyacrylic acid, polymaleic acid, poly(vinyl toluene sulfonic acid), poly(styrene sulfonate-co-maleic acid), poly(vinyltoluene sulfonate-co-maleic acid), poly styrene carboxylate, poly(alkylvinyl ether-co-maleic acid), sulfonated polyvinyl alcohol, poly(acrylamide-co-2-acrylamido-2-methylpropane carboxylate), poly(acrylamide-co-2-acrylamido-2-methylpropane sulfonate), poly(styrene sulfonate-co-acrylamide), poly acrylic acid, poly(styrene carboxylate-co-acrylamide), poly(2-acrylamido-2-methylpropane sulfonate-co-maleic acid), poly(4-styrene sulfonic acid), poly(2-acrylamido-2-methyl-1-propanesulfonic acid), a salt thereof, derivative thereof, or a combination thereof. Commercially available organic polymers with anionic functional groups (i.e., cation exchange polymers) include sulfonated copolymers of styrene and divinylbenzene (CG10-BL available from Resintech) and copolymers of polyacrylic acid and divinylbenzene (WACG-NA available from Resintech).

In another embodiment, the organic polymer has a basic or cationic functional group so that it is an anion exchange polymer. The basic functional group is, for example, a primary amino group, secondary amino group, tertiary amino group, or a combination thereof. The cationic functional group is, for example, a quaternary ammonium group, quaternary phosphonium group, tertiary sulfonium group, alkyl pyridinium group, or a combination thereof. Anion exchange polymers can be classified as strong or weak according to the degree of ionization of the functional group. Similarly, cation exchange polymers discussed above may also be classified as strong or weak.

Strong base anion exchange polymers include, for example, a quaternary ammonium anion exchange polymer. As used herein, “strong base anion exchange polymer” refers to organic polymers that either contain strongly basic cationic groups, e.g., quaternary ammonium groups (—NR₃⁺, where each R may be the same or different group, for example an alkyl or aryl group) or that have strongly basic properties which are substantially equivalent to quaternary ammonium anion exchange polymers.

A number of quaternary ammonium anion exchange polymers as well as other strong base anion exchange polymers (e.g., tertiary sulfonium polymers, quaternary phosphonium polymers, alkyl pyridinium polymers, and the like) are commercially available. Examples of commercially available organic polymers with cationic functional groups that are strong base anion exchange polymers include SBACR-OH and SBG1 (from Resintech); Amberlite IRA-401 S, Amberlite IR-400 (Cl⁻), Amberlite IR-400 (OH⁻), and Amberlite IR-402 (Cl⁻) (from Rohm & Hass). These polymers may be obtained in a granular form and may contain, for example, quaternary ammonium exchange groups bonded to styrene-divinylbenzene polymer chains.

As used herein, “weak base anion exchange polymer” refers to organic polymers that either contains weakly basic cationic groups or that have weakly basic properties that are substantially equivalent to primary, secondary or tertiary amines These include polymers that have cationic functional groups containing a primary amine (—NH₂), secondary amine (—NHR, where R may be, for example, an alkyl or aryl group), tertiary amine (—NR₂, where each R may be the same or different group, for example an alkyl or aryl group), or combination thereof. Examples of such functional groups include aminoethyl, dimethylaminoethyl, diethylaminoethyl and similar groups.

Commercially available weak base anion exchange polymers include those marketed, for example, under the trade names of LEWATIT (manufacturer Bayer AG), DOWEX (manufacturer Dow Chemical), DIAION, and RELITE (manufacturer Mitsubishi Chemical), PUROLITE (manufacturer Purolite); AMBERLITE, AMBERLYST and DUOLITE (manufacturer Rohm and Haas), SERDOLIT (manufacturer Serva Heidelberg GmbH), and FINEX (manufacturer Finex-FX Oy). Examples of weak base anion exchange polymers include those marketed under the trade names LEWATIT A-365, DOWEX M-43, DIAION WA30, RELITE EXA133, PUROLIT A100DL, Amberlite IRA67, Amberlite IRA68, Amberlyst A-21, DUOLITE A7, and SERDOLIT AW-1.

The organic polymer with cationic functional groups can have a counter ion (host ion) associated with the cationic functional group such as hydroxide, halide, sulfate, and the like. As noted above, the host ion can be exchanged with fluid ions in a fluid in a downhole application that uses the ion exchange material.

The organic polymer can be, for example, a plurality of particles. The particles have a large surface area to volume ratio for efficient contact with fluid and ion exchange. In addition, the density of pores of the particles is high for efficient contact with fluid and ion exchange. The particle size (with respect to the largest linear dimension of such particles) can be from about 0.2 mm to about 0.8 cm, specifically from about 0.35 mm to 56 mm, and more specifically from about 1 mm to about 10 mm. The organic polymer can be, for example, in a particle form such as in beads or a powder or can be included in a membrane or embedded in a fibrous matrix.

The anion exchange polymers can be in a salt form where the host ion is, for example, a halide (e.g., chloride or bromide) or various other forms, for example, a hydroxide (OH⁻) form. Similarly, the cation exchange polymers can be in a salt form where the host ion is, for example, hydrogen or an alkali metal (e.g., lithium, sodium, or potassium).

As an alternative to or in addition to the organic polymers with charged functional groups above described, the ion exchange materials may include an inorganic mineral. Thus, in an embodiment, a downhole article includes an inorganic ion exchange material and a composition. The composition can swell and includes an elastomer and an absorbent material, which will be described below.

According to an embodiment, the inorganic ion exchange material is, for example, a zeolite, silica, alumina, titania, or a combination thereof.

Zeolites are typically porous aluminosilicate compounds. Structurally, aluminosilicates include SiO₄/AlO₄ tetrahedral units, where the Si and Al are linked together through bridging oxygen atoms in a three-dimensional network that has cages and/or channels. These cage and channel structural features can impart chemical properties to the zeolite.

Zeolites have an overall negative charge and accommodate positively charged counter ions, such as Na⁺, K⁺, Ca²⁺, Mg²⁺, and the like. The zeolite may be a hydrophilic zeolite (e.g., X, A, or chabazite zeolites) or hydrophobic zeolite (e.g., Y, siliceous zeolite, silicate, or silicalite). The zeolites herein typically are prepared with host ions. The positive counter ions (host ions) in the zeolite cages (or channels) can be readily exchanged with cations from a fluid that contacts the zeolite.

Examples of zeolites that can be used for ion exchange include naturally occurring zeolites such as amicite, analcime, barrerite, bellbergite, bikitaite, boggsite, brewsterite, chabazite, clinoptilolite, cowlesite, dachiardite, edingtonite, epistilbite, erionite, faujasite, ferrierite, garronite, gismondine, gmelinite, gobbinsite, gonnardite, goosecreekite, harmotome, herschelite, heulandite, laumontite, levyne, maricopaite, mazzite, merlinoite, mesolite, montesommaite, mordenite, natrolite, offretite, paranatrolitem, paulingite, pentasil, perlialite, phillipsite, pollucite, scolecite, sodium dachiardite, stellerite, stilbite, tetranatrolite, thomsonite, tschernichite, wairakite, wellsite, willhendersonite, and yugawaralite. In some embodiments, the zeolite is analcime, chabazite, clinoptilolite, heulandite, natrolite, phillipsite, stilbite, or a combination thereof.

Moreover, a synthetic zeolite also can be used as the inorganic ion exchange material. The synthetic zeolites can be selected from Zeolite A, Zeolite B, Zeolite F, Zeolite H, Zeolite L, Zeolite T, Zeolite W, Zeolite X, and Zeolite Y, Zeolite Omega, Zeolite ZSM-5, Zeolite ZSM-4, Zeolite P, Zeolite N, Zeolite D, Zeolite O, Zeolite S, and Zeolite Z.

According to an embodiment, the zeolite is selected from analcime, chabazite, clinoptilolite, heulandite, natrolite, phillipsite, stilbite, Zeolite A, Zeolite B, Zeolite X, Zeolite Y, Zeolite Omega, Zeolite ZSM-5, Zeolite ZSM-4, or a combination thereof.

The ion exchange material exchanges cations, anions, or a combination thereof. Moreover, the ion exchange material can be a combination of the organic polymer or inorganic ion exchange material. In an embodiment, the ion exchange polymer exchanges positive host ions for fluid ions (cations) such that the host ions have an ionic charge the same or less positive than that of the fluid ions. It should be appreciated that the host ions are bound to a functional group of the ion exchange material before ion exchange occurs.

In particular, the host ions are monovalent ions, and the fluid ions are polyvalent ions, e.g., divalent or trivalent ions. In an embodiment, the host ions are cations of elements selected from Group 1 of the periodic table. In a particular embodiment, the host ions are selected from hydrogen, lithium, sodium, potassium, or a combination thereof.

The fluid ions can be selected from Group 1, Group 2, Group 3, Group 4, Group 5, Group 6, Group 7, Group 8, Group 9, Group 10, Group 11, Group 12 of the periodic, or a combination thereof. Examples of the fluid ions include calcium, magnesium, chromium, iron, cobalt, tungsten, nickel, copper, zinc, aluminum, or a combination thereof. The fluid ions can be in any of their ionic states, for example, iron as Fe²⁺, Fe³⁺, or a combination thereof.

In another embodiment, the ion exchange polymer exchanges negative host ions for fluid ions (anions), the host ions having an ionic charge the same or more positive than that of the fluid ions. The fluid ions can be selected from halide, nitrate, sulfate, formate, carbonate, acetate, propionate, or a combination thereof. These fluid ions are components of typical downhole fluids. The host ions can be selected from, for example, hydroxide, halide, sulfate, nitrate, or a combination thereof.

The ion exchange material can be selected to produce specific effects in a downhole environment. According to an embodiment, the ion exchange material is amphoteric so that it includes both anionic and cationic functional groups. Here, the host ions can be protons (H⁺) and hydroxide (OH⁻), respectively. When the ion exchange material exchanges host ions for fluid ions (e.g., Zn²⁺ and Br^{-), H}⁺ and OH⁻ are dissociated (i.e., released) by the ion exchange material and can recombine in the fluid to form water. Alternatively, the ion exchange material can be selected to exchange only cations or anions with a fluid. Depending on the particular host ions initially present in the ion exchange material, the salinity of the fluid can be increased or decreased as ion exchange occurs. Moreover, the ion exchange material can be selected to affect the pH of the downhole environment. For example, a protonated cation exchange polymer or zeolite can decrease the pH while a hydroxide host ion on an anion exchange polymer can increase the pH of the downhole environment.

In an embodiment, the composition includes an elastomer and absorbent material. The composition disclosed herein provides excellent swelling volumes. A combination of at least two polymer families, as well as the optimization of other components, provides a composition for use in downhole applications that can swell in fluids such as water-based muds or brines. In one non-limiting embodiment, a cellulose component, such as carboxymethyl cellulose (CMC), is used together with an acrylate copolymer (AC) that can increase the swelling capacity of an acrylonitrile butadiene rubber (NBR) in water to over 1000%. The amount and rate of swelling of the composition depend on availability of fluid to access the absorbent material in the composition. As described more fully below, the ion exchange material can control the expansion behavior of the composition by exchanging polyvalent ions in a fluid, which can inhibit the swell properties of the absorbent material.

According to an embodiment, the swellable composition described herein is a nitrile-based formulation, i.e., the elastomer includes nitrile components. A water-swelling absorbent material such as copolymer that is emulsified in a nitrile soluble oil allows incorporation of this copolymer/oil mixture into the nitrile base polymer. In addition to these two materials, several other materials such as fillers and curatives can be added to give the composition strength and suitable final properties. A cellulosic material as part of the absorbent material can be added to the composition to enhance fluid absorption.

The elastomer base polymer can be an acrylonitrile butadiene rubber (NBR) and/or any polymer that is tolerated by or compatible with a liquid dispersed polymer (LDP) described below or to be developed. NBR is a family of unsaturated copolymers of 2-propenenitrile and various butadiene monomers (1,2-butadiene and 1,3-butadiene). Although its physical and chemical properties vary depending on the elastomer base polymer's content of acrylonitrile (the more acrylonitrile within the elastomer base polymer, the higher the resistance to oils but the lower the flexibility of the material), this form of synthetic rubber is generally resistant to oil, fuel, and other chemicals. Other types of NBR can also be used as the elastomer base polymer, for example, hydrogenated NBR (HNBR), carboxylated hydrogenated NBR (XHNBR), and NBR with some of the nitrile groups substituted by an amide group (referred to as amidated NBR or ANBR). Herein, NBR will pertain to any the aforementioned types. Suitable, but non-limiting examples of NBR include, but are not limited to NIPOL™ 1014 NBR available from Zeon Chemicals, LP; Perbunan NT-1846 from LanXess or N22L from JSR. Given a suitable LDP, other elastomer base polymers can include, but are not necessarily limited to, ethylene-propylene-diene monomer copolymer rubber (EPDM), synthetic rubbers based on polychloroprene (NEOPRENE™ polymers from DuPont), fluorinated polymer rubbers (e.g. FKM), tetrafluoro ethylene propylene rubbers (FEPM, such as AFLAS™ fluoroelastomers available from Asahi Glass Co. Ltd.), fluorosilicone rubber (FVMR), butyl rubbers (IIR), and the like.

Although NBR does not swell significantly in water, addition of an absorbent material such as an acrylic copolymer (AC) and a cellulosic material provide extremely high swelling capacity. In an embodiment, the acrylic copolymer is dispersed in a nitrile-compatible phthalate ester, and the cellulosic material is a carboxymethyl cellulose (CMC).

According to an embodiment, the absorbent material is an acrylic copolymer that is a mixture comprised of approximately 50% active polymer and 50% phthalate ester oil carrier. Examples of this material include, but are not necessarily limited to, those produced by CIBA Specialty Chemicals (UK) for use in PVC, as well as any other material generally regarded as a super absorbent polymer (SAP) in solid or liquid form. This oil/polymer blend is referred to herein as liquid dispersed polymer (LDP). However, it should be understood that other LDPs besides the above-described one are expected to be useful in the water swellable composition herein. In a non-limiting example, another potentially suitable LDP available from CIBA Specialty Chemicals is one that is based in either a paraffinic, naphthenic, or aromatic based oil or any combination thereof, which is compatible with EPDM. Thus, EPDM is another possibility for the elastomer base polymer herein, and other oils besides phthalate esters are also expected to be suitable. It will be appreciated that this LDP material can have ratios other than 50% polymer and 50% oil carrier and still be useful and effective for the purposes and compositions described herein. Another alternative material includes AQUALIC CS-6S, a water absorbent polymer available from Nippon Shokubai Co., Ltd. in solid powder form.

The composition benefits from the combined swelling effects of the LDP and the CMC. The composition can swell with either alone, but there are physical limitations of adding each. For instance, the LDP can be a liquid, and the cellulose can be a dry powder. Without wishing to be limited to any particular explanation, it is believed that there is no or substantially little chemical interaction occurring between the two components. However, there may be a physical interaction of water transference between the two additives, although the inventors do not want to be restricted by this theory. There appears to be a synergistic effect between the two that ultimately yields a composition that has more swelling ability, more desirable processing, and better physical properties as compared to otherwise identical composition where one or the other additive is not included. The CMC being a solid powder helps to absorb the oil portion of the LDP, contributes strength to the rubber as well as making the rubber less soft during processing while ultimately having a greater hardness when cured.

The amount of these three ingredients (NBR, LDP, and CMC) is about 15 weight percent (wt. %) to about 35 wt. % for each, based on the weight of the composition. Normally, the amount of components in a rubber composition is expressed in terms of parts per hundred parts rubber (phr). Such compositions start with 100 parts of raw polymer and then other materials are expressed in parts compared to that. In one non-limiting embodiment, the elastomer base polymer is 100 phr NBR and about 18 vol. % to about 52 vol. % ACN (acrylonitrile). In the composition, the amount of LDP is from about 80 phr to about 140 phr. This equivalent to about 40 phr to about 70 phr of the swelling AC. The high oil content may become a limiting factor as to how much of the LDP may be physically added to the NBR. If a higher concentration of the swelling polymer was to become commercially available, then the phr range of 80-140 would still be applicable, however, the active level of polymer would increase beyond the current 40-70 phr range that should result in an elastomer capable of even higher swelling. The amount of the CMC thus would be from about 50 phr to about 150 phr.

Examples of the absorbent material that are acrylic copolymers include, but are not limited to, copolymers of acrylic acid and its esters with other materials such as polyacrylamide copolymer, ethylene maleic anhydride copolymer, crosslinked carboxymethylcellulose (CMC), polyvinyl alcohol copolymers, crosslinked polyethylene oxide, and starch grafted copolymer of poly ACN. Cellulose is a general name and in general a commodity. One non-limiting, example is chemically referred to as carboxymethyl cellulose (CMC) and is generally sold under some form of this name. Other examples of CMC include AKUCELL™ AF3281 CMC available from Akzo Nobel, CMC from Aqualon, and CMC from Quingdae Rich Chemicals. Other general cellulosic materials such as hydroxypropylmethyl cellulose (HPMC) or methylcellulose (MC) and combinations thereof that function to accomplish the properties and goals of the water swellable composition and which are compatible with the other components are acceptable for use herein.

The NBR (or other elastomer base polymer) can be crosslinked. The crosslinks can be a product of crosslinking the polymer by sulfur, peroxide, urethane, metallic oxides, acetoxysilane, and the like. In particular, a sulfur or peroxide crosslinker is used.

In another embodiment, the elastomer is compounded with an additive either before or after being combined with the absorbent material and/or the ion exchange material. “Additive” as used herein includes any compound added to the elastomer to adjust the properties of the composition, for example, a blowing agent to form a foam, a filler, or processing aid, provided that the additive does not substantially adversely impact the desired properties of the swellable composition, for example, corrosion resistance at high temperature.

Fillers include reinforcing and non-reinforcing fillers. Reinforcing fillers include, for example, silica, glass fiber, carbon fiber, or carbon black, which can be added to the composition to increase strength. Non-reinforcing fillers such as polytetrafluoroethylene (PTFE), molybdenum disulfide (MoS₂), or graphite can be added to the composition to increase the lubrication. Nanofillers are also useful, and are reinforcing or non-reinforcing. Nanofillers, such as carbon nanotubes, nanographenes, nanoclays, polyhedral oligomeric silsesquioxane (POSS), or the like, can be incorporated into the composition to increase the strength and elongation of the material. Nanofillers can further be functionalized to include grafts or functional groups to adjust properties such as solubility, surface charge, hydrophilicity, lipophilicity, and other properties. Silica and other oxide minerals can also be added to the composition. Combinations comprising at least one of the foregoing fillers can be used.

A processing aid is a compound included to improve flow, moldability, and other properties of the composition, which may have interposed ion exchange material therein. Processing aids include, for example an oligomer, a wax, a resin, a fluorocarbon, or the like. Exemplary processing aids include stearic acid and derivatives, low molecular weight polyethylene, and the like. Combinations comprising at least one of the foregoing fillers can be used.

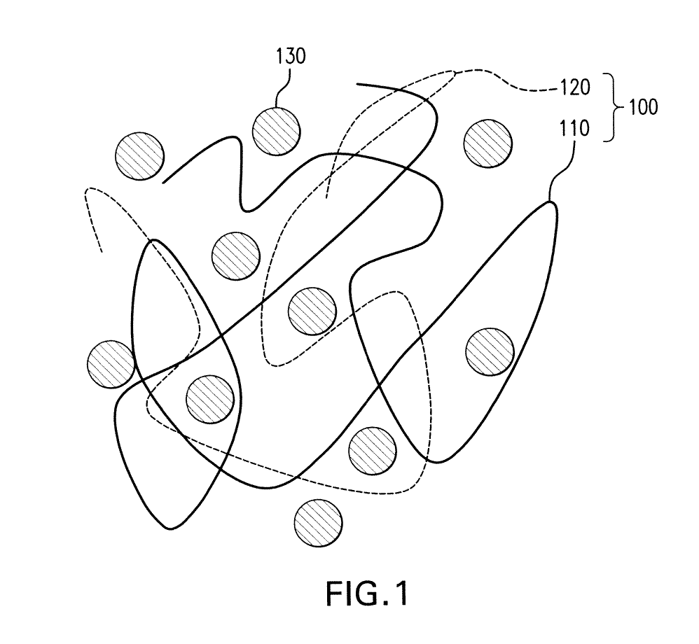

FIG. 1 shows ion exchange material 130 interposed among a composition 100 that includes an elastomer 110 and an absorbent material 120. In other embodiments, the ion exchange material may be disposed on the composition 100 as well being interposed with the elastomer 110 and the absorbent material 120. In another embodiment, the ion exchange material 130 is disposed on the composition as a surface coating without being interposed with the elastomer 110 and the absorbent material 120. The coating can cover the entirety of the composition 100 or only a portion of the composition 100.

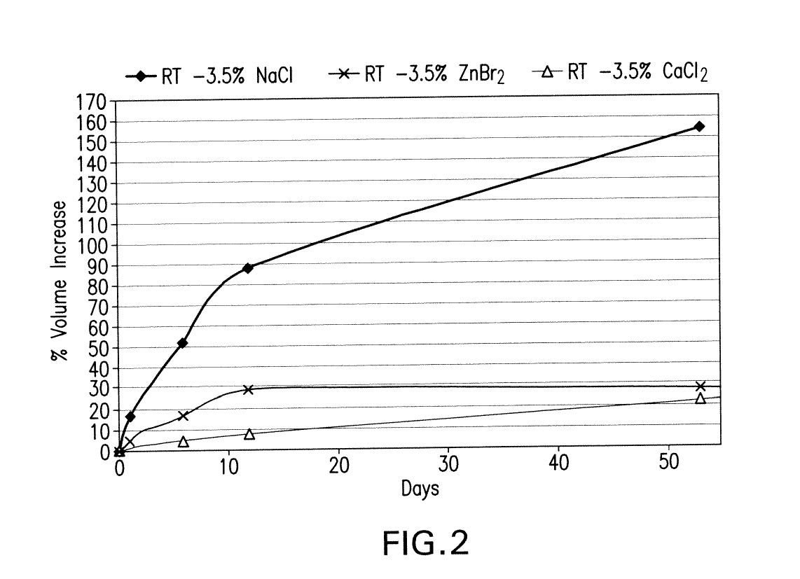

The amount of the ion exchange material present with the composition is that amount effective to exchange polyvalent ions from a fluid in order to maintain the absorption and expansion properties of the composition. In an embodiment, the ion exchange material is present in an amount effective such that the composition maintains from about 50% to about 100%, more specifically from about 70% to about 100%, and more specifically about 85% to about 100%, of the overall volumetric expansion of the composition in water that is substantially free of polyvalent ions (see FIG. 2). According to an embodiment, the amount of the ion exchange present with the composition is from about 0.01 weight percent (wt. %) to about 50 wt. %, specifically about 0.1 wt. % to about 20 wt. %, based on the weight of the composition.

In an embodiment, the elastomer is combined with the absorbent material to form the composition. According to an embodiment, pellets or powders of the elastomer and absorbent material are combined, for example, by mixing in a blender. This may occur in a dry or liquid phase. The composition can be dried if wet and subsequently coated with ion exchange material. Alternatively, the composition can be combined with ion exchange material and mixed to disperse the ion exchange material among the components of the composition. This combination can then be pelleted, compressed, and molded into a shape at a temperature and pressure effective to produce a desired article. The combination can also be cut or processed by numerous methods as know by one in the art.

The combination of the composition and ion exchange material has many uses and is highly efficient at expansion due to the absorption of fluid having decreased amounts of polyvalent ions due to the ion exchange material. Such uses include downhole articles, which are described more fully below. To illustrate properties and benefits of the combination, FIG. 2 shows the inhibiting effect of various salts on the volumetric expansion of the composition without ion exchange material. Here, the graph in FIG. 2 shows the percentage volume increase of the composition as a function of different salts over time for a water swelling composition (without ion exchange material) contacting three different water solutions. The water solutions are 3.5% NaCl, 3.5% ZnBr₂, and 3.5% CaCl₂ at room temperature. At over 50 days, the composition has over a 150%. vol (percent volume) increase in 3.5% NaCl. In comparison to the 3.5% NaCl solution, the percent volume increase of the composition is decreased by more than five times in 3.5% ZnBr₂. Furthermore, 3.5% CaCl₂ decreases the percent volume increase by 7.5 times as compared to the NaCl solution. Thus, these data substantiate the fact that fluids, for example, brine, that contain polyvalent cations (Ca²⁺, Zn²⁺, etc.) inhibit swelling more significantly than fluids that contain singly charged cations (Na⁺, K⁺, etc.). Without wishing to be bound by theory, it is believed that polyvalent ions effectively block fluid absorption sites of the absorbent material. For example, monovalent ions have a smaller radius of solvation than polyvalent ions, particularly for elements occurring in the same row of the periodic table. As polyvalent ions occupy the interstitial space in a swellable composition without the ion exchange material described herein, the polar groups of the absorbent material (e.g., hydroxyl groups of the carboxymethylcellulose) induce polarization of the electron cloud of the polyvalent ions more efficiently than for monovalent ions. As a result, not only are the polyvalent ions larger and block a greater portion of absorption sites, but the polyvalent ions also are more tightly held to the absorption sites due to electrostatic effects such as dipole coupling between the polar groups and the polyvalent ions.

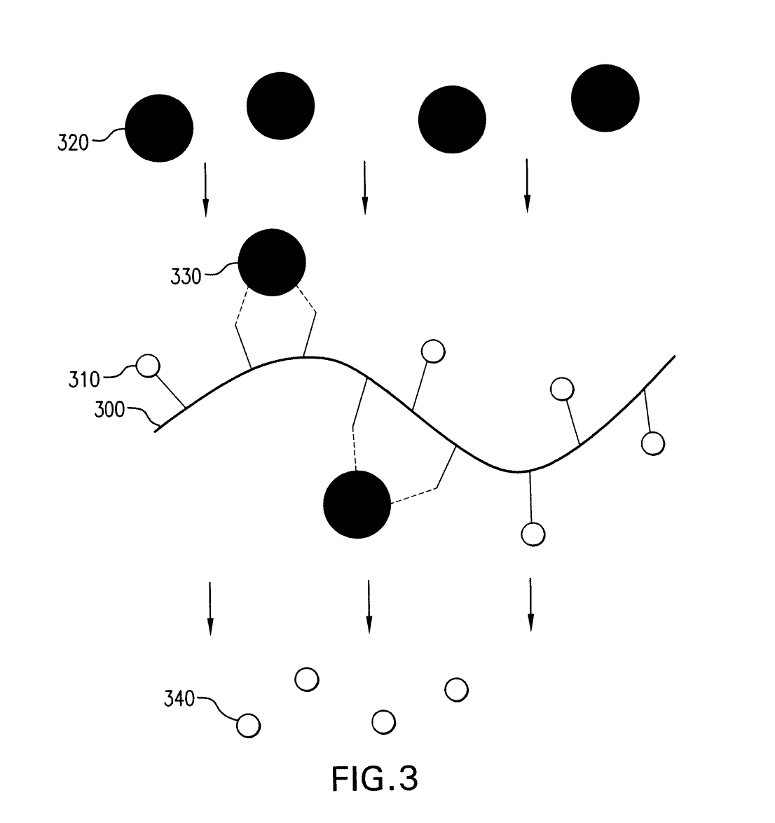

The ion exchange material mitigates the inhibiting effects of polyvalent ions on the swell properties of the composition by exchanging and binding polyvalent ions while donating ions of lesser charge to the fluid. As shown in FIG. 3, an ion exchange material 300 has host ions 310 (e.g., monovalent ions) attached thereto. Fluid ions 320 (e.g., polyvalent ions) contact the ion exchange material 300, and multiple host ions 310 dissociate from the ion exchange material 300. The dissociated host ions are shown as free host ions 340. After host ions 340 dissociate from the ion exchange material 300, the fluid ions 330 bind to the ion exchange material. Thus, host ions 340 are donated to the fluid to replace fluid ions 320 as fluid ions 330 bind to the ion exchange material 300. Consequently, polyvalent ions are decreased or depleted in the fluid and are replaced with ions of lower charge, for example monovalent ions. These monovalent ions impact the percent volume increase of the composition to a substantially smaller degree with respect to polyvalent ions as illustrated in FIG. 2.

The swellable compositions with the ion exchange material herein may find a wide variety of uses. A non-limiting embodiment is a downhole article used in hydrocarbon recovery operations. In particular, the water-swellable compositions are expected to be useful as selectively deployed sealing elements for flow channels, particularly well flow channels such as annuli and the like. Suitable downhole articles for use in hydrocarbon exploration and recovery operations include, but are not necessarily limited to, packers, bridge plugs, expandable pipes, or any other borehole article requiring a swelling or expanding area to seal or block fluid flow. Such articles, once deployed, swollen, enlarged, and/or expanded are usually not desired to shrink and be extracted. In some non-limiting instances, the elastomeric seals may shrink should they no longer contact an aqueous fluid and be allowed to “dry out,” but this is unlikely in a downhole application.

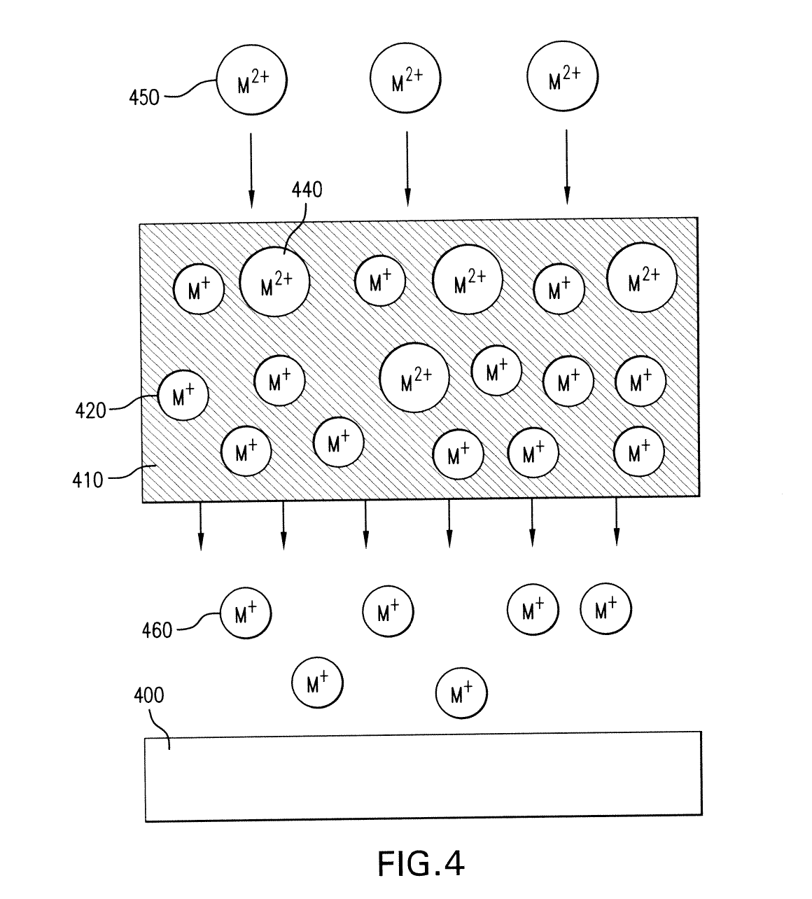

According to an embodiment, a downhole article, as shown in FIG. 4, includes an ion exchange material 410 disposed on a swellable composition 400 containing an elastomer and absorbent material. As fluid ions 450 traverse the ion exchange material 410, host ions 420 dissociate from the ion exchange material 410 and replace fluid ions 450 as host ions 460 in the fluid. Here, a single divalent M²⁺ ion 440 replaces two monovalent M⁺ ions 420 in the ion exchange material. As a result, the downhole article swells as the size of the swellable composition 400 volumetrically increases since polyvalent ions 450 do not block fluid absorption sites of the composition 400 in contrast to the large extent that polyvalent ions block such sites.

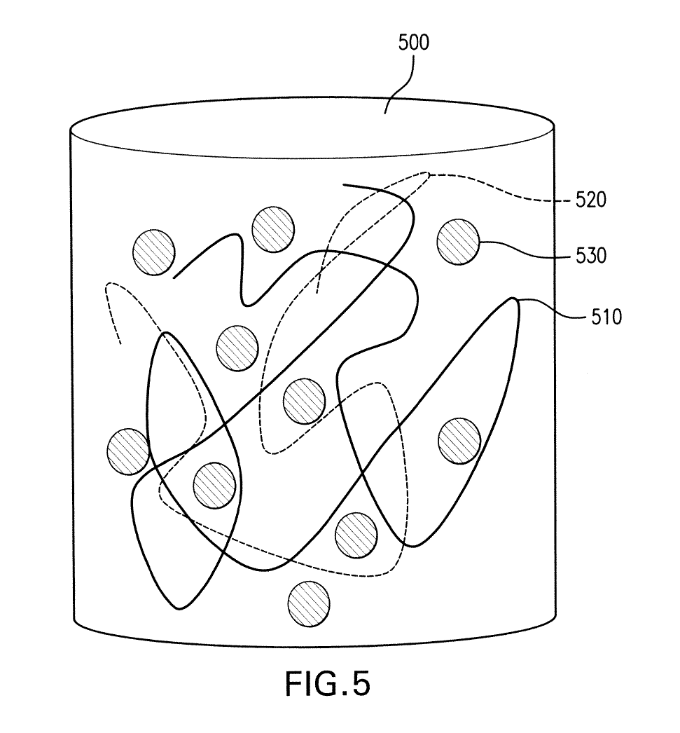

In another embodiment, as shown in FIG. 5, a packer 500 includes ion exchange beads 530 disposed in a swellable composition having an elastomer 510 and absorbent material 520. In yet another embodiment, the ion exchange material can be disposed in a fibrous matrix. The fibrous matrix can be placed over the downhole article. Examples of the fibrous matrix include polyester fibers, glass fibers, nylon fibers, and the like.

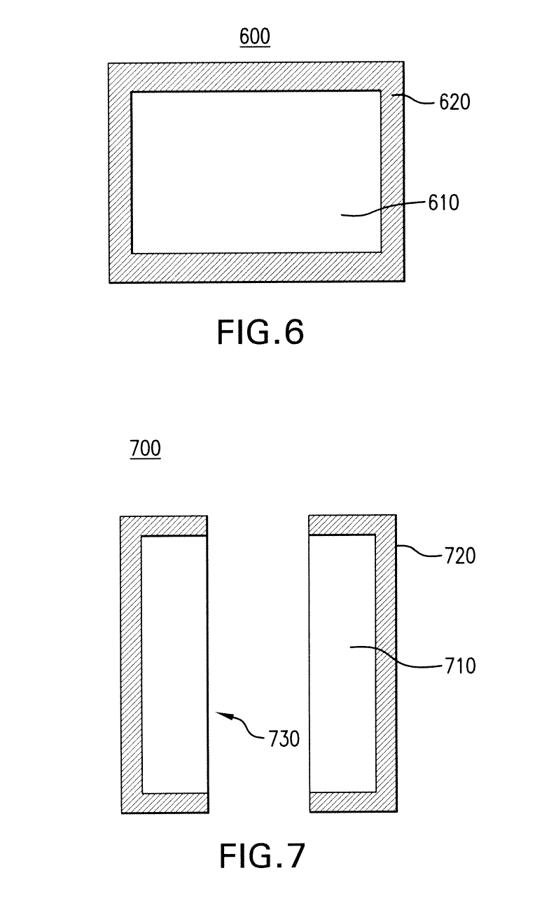

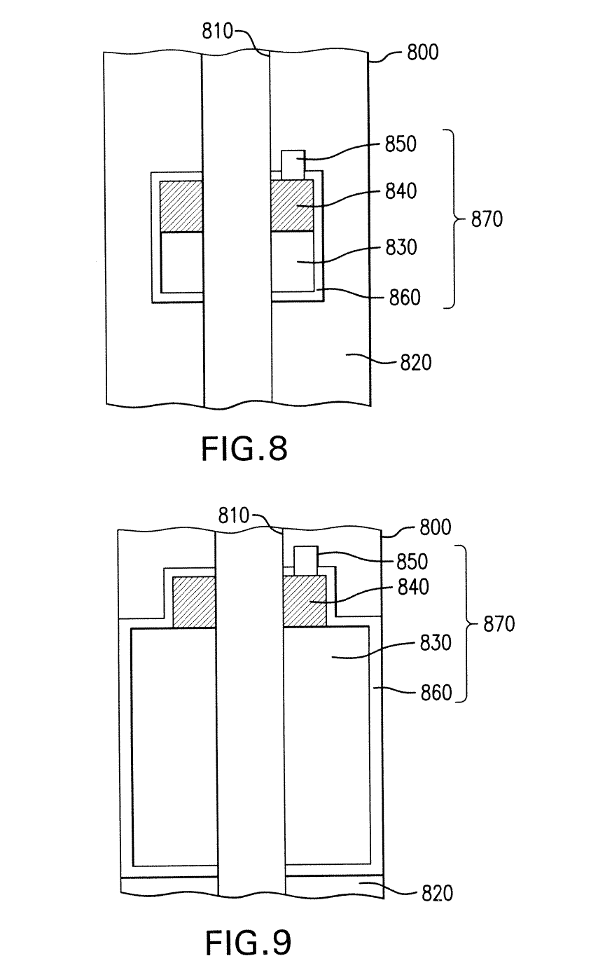

Other formats of the downhole article can be made. FIG. 6 shows a cross-section of a downhole article 600 having swellable composition 610 completely covered by ion exchange material 620. On the other hand, FIG. 7 shows a downhole article 700, with ion exchange material 720 partially covering a swellable composition 710. In this embodiment, the downhole article 700 has an inner diameter 730 that can accept, for example a tube. In a non-limiting embodiment, the downhole article (600 and 700) can further have an elastomer coating (not shown) disposed on its outside surface, e.g., completely covering the downhole article. Such an elastomer is impermeable to downhole fluid to protect the swellable composition and ion exchange material from premature contact with downhole fluid. The elastomer can be any elastomeric material that is impermeable to downhole fluid, including those elastomers described above that are impermeable to downhole fluid, e.g., VITON elastomer. An orifice or valve (described below) can be attached to the downhole article to control fluid communication between the downhole environment and the ion exchange material and swellable composition (see FIGS. 8 and 9). The valve traverses or penetrates the elastomer so that downhole fluid can flow through the valve to contact the ion exchange material.

In an embodiment illustrated in FIGS. 8 and 9, an annular space 820 between a pipe 810 and a borehole wall 800 contains a borehole fluid. A downhole article (e.g., a packer) 870 including a swellable composition 830, ion exchange material 840, elastomer 860, and valve 850 is placed in the borehole. The cross-sectional area of the downhole article 870 is less than the borehole diameter since the swellable composition 830 is smaller than the borehole in a first or initial size of the packer 870, which allows the packer 870 to be placed easily into the correct location downhole. In this initial state, the swellable composition 830 has not expanded to an appreciable amount because the elastomer 860 is impermeable to downhole fluid. The elastomer 860 can be any elastomeric material that is impermeable to downhole fluid, including those elastomers described above that are impermeable to downhole fluid, e.g., VITON elastomer.

When the downhole article 870 is used for isolating borehole zones, the swellable composition 830 remains in an unexpanded state (i.e., initial size) while the ion exchange material 840 does not contact the downhole fluid during run-in until the packer 870 reaches the desired downhole location. Usually, downhole tools travel from surface to the desired downhole location in a number of hours or days. If the ion exchange material 840 were in contact with polyvalent ions during run-in, the ion exchange material would saturate with polyvalent ions. As a result, the swellable composition 830 would fail to seal the borehole due to incomplete swelling since the composition's absorption sites would be blocked by polyvalent ions. To avoid undesired polyvalent ion saturation of the ion exchange material 840 during run-in, mitigation features can be used, e.g., the elastomer 860. According to an embodiment, the ion exchange material 840 and swellable composition 830 are coated with the elastomer 860. The elastomer 860 is impermeable to downhole fluid and protects the swellable composition 830 and ion exchange material 840 from premature contact with downhole fluid.

The valve 850 can be, for example, a needle valve plugged with a degradable material, a water-soluble polymer, or a controlled electrolytic material (CEM) such as magnesium or its alloys, or a combination thereof. The CEM is controllably dissolved by contact with certain downhole fluids. After the CEM coating is removed from the valve 850, fluid flows through the valve 850, and the ion exchange material 840 exchanges ions with the downhole fluid so that the swellable composition 830 expands, causing the packer 870 to seal the borehole as described above. That is, when the downhole article 870 reaches its destination downhole, the CEM is removed from the valve 850 in the course of an electrochemical reaction so that valve 850 is opened to admit downhole fluid, which contacts the ion exchange material 840 that exchanges fluid polyvalent ions with monovalent ions. The fluid with monovalent ions subsequently contacts the swellable composition 830, and the swellable composition 830 expands due to fluid absorption. As a result, the downhole article 870 (with the swellable composition 830 in its expanded state) conforms to and seals the borehole as shown in FIG. 9. Thus, the packer 870 expands (swells) to be deployed in a second shape and volume, sealing the annular space 820 by conforming to the borehole wall 800 and outer diameter of the pipe 810. In this manner, the borehole is sealed.

The CEM contains an alloy, which dissolves in a corrosive environment. The CEM can be a magnesium alloy such as described in U.S. patent application Ser. No. 13/194,271, the content of which is incorporated herein by reference in its entirety. In an embodiment, the CEM contains a metal selected from Group 2, Group 3, Group 4, Group 5, Group 6, Group 7, Group 8, Group 9, Group 10, Group 11, Group 12, Group 13, lanthanoid series, actinoid series of the periodic table, or a combination thereof. In an embodiment, the metal is, aluminum (Al), calcium (Ca), cobalt (Co), copper (Cu), chromium (Cr), gallium (Ga), indium, (In), iron (Fe), magnesium (Mg), manganese (Mn), molybdenum (Mo), nickel (Ni), palladium (Pd), tungsten (W), silicon (Si), silver (Ag), tin (Sn), titanium, (Ti), vanadium (V),yttrium (Y), zinc (Zn), zirconium (Zr), an alloy thereof, or a combination thereof. Here, the CEM can be removed by a water-based electrolyte such as a carboxylic acid aqueous solution, brine, and the like.

In particular, the swellable compositions with the ion exchange material herein are expected to be used in borehole isolation products similar to the Reactive Element Packer (REPackers) and FORMPAC™ packers, which are considered expandable tools, all available from Baker Hughes. Expandable articles are made from special pipe that is swaged when in place, which thins and expands the pipe to make it larger by about 20-25%. Adding or applying the swelling composition with the ion exchange material to the outside of this pipe allows the article to seal in a slightly larger or irregular hole than the expandable pipe could do on its own and without the swelling inhibition caused by polyvalent ions.

As illustrated above, in an embodiment, a method of maintaining expandability of a downhole article includes disposing a downhole article comprising an elastomer, absorbent material, and an ion exchange material in a borehole. The ion exchange material comprises host ions. The method also includes exchanging fluid ions in a fluid with host ions from the ion exchange material to maintain the expandability of the downhole article. Additionally, the method further includes binding the fluid ions by the ion exchange material; traversing, by the fluid, the ion exchange material before contacting the absorbent material; and sealing the borehole with the downhole article. In an embodiment, the fluid ions are polyvalent cations, and the host ions are monovalent cations. In another embodiment, the fluid and host ions are anions. In yet another embodiment, the fluid and host ions are a combination of cations and ions. The host ions that dissociate from the ion exchange material can combine to form water.

In a further embodiment, a system for sealing a borehole includes a downhole sealant to seal the borehole and an ion selective member to cover the downhole sealant. The downhole sealant contains an elastomer and an absorbent material. The ion selective member includes an ion exchange material. The downhole sealant expands to seal the borehole in response to the absorbent material absorbing a fluid. In an embodiment, the ion exchange material exchanges polyvalent ions the fluid with host ions from the ion exchange material. In another embodiment, the ion selective member is fibrous.

The use of the terms “a,” “an,” “the,” and similar referents in the context of the description and the claims are to be construed to cover both the singular and the plural, unless otherwise indicated herein or clearly contradicted by context. The terms “first,” “second,” and the like herein do not denote any order, quantity, or importance, but rather are used to distinguish one element from another. All ranges disclosed herein are inclusive of the endpoints, and the endpoints are independently combinable with each other.

As used herein, “combination” is inclusive of blends, mixtures, alloys, reaction products, and the like. “Elastomer” as used herein is a generic term for substances emulating natural rubber in that they stretch under tension, have a high tensile strength, retract rapidly, and substantially recover their original dimensions. The term includes combinations (physical mixtures) of elastomers, as well as copolymers, terpolymers, and multi-polymers.

While one or more embodiments have been shown and described, modifications and substitutions may be made thereto without departing from the spirit and scope of the invention. Accordingly, it is to be understood that the present invention has been described by way of illustrations and not limitation.

What is claimed:

1. A downhole article comprising:
an ion exchange polymer; and
a composition comprising:
an elastomer; and
an absorbent material.

2. The downhole article of claim 1, wherein the ion exchange polymer is disposed in the composition.

3. The downhole article of claim 2, wherein the ion exchange polymer is disposed on a surface of the composition.

4. The downhole article of claim 1, wherein the ion exchange polymer is disposed on a surface of the composition.

5. The downhole article of claim 4, wherein the composition has a first shape, the ion exchange polymer has a second shape, and the outer diameter of the first shape is less than the outer diameter of the second shape.

6. The downhole article of claim 4, wherein the composition has a first shape, the ion exchange polymer has a second shape, and the outer diameter of the first shape is greater than or equal to the outer diameter of the second shape, as a result of swelling of the composition.

7. The downhole article of claim 1, wherein the ion exchange polymer exchanges cations.

8. The downhole article of claim 7, wherein the ion exchange polymer exchanges host ions for fluid ions, the host ions having an ionic charge the same or less positive than that of the fluid ions.

9. The downhole article of claim 8, wherein the fluid ions are calcium, magnesium, chromium, iron, cobalt, tungsten, nickel, copper, zinc, aluminum, or a combination thereof.

10. The downhole article of claim 9, wherein the host ions are bound to a functional group of the ion exchange polymer before exchange occurs.

11. The downhole article of claim 10, wherein the host ions are selected from hydrogen, lithium, sodium, potassium, magnesium, calcium, or a combination thereof.

12. The downhole article of claim 1, wherein the ion exchange polymer exchanges anions.

13. The downhole article of claim 12, wherein the ion exchange polymer exchanges host ions for fluid ions, the host ions having an ionic charge the same or more positive than that of the fluid ions.

14. The downhole article of claim 13, wherein the fluid ions are selected from halide, nitrate, sulfate, formate, carbonate, acetate, propionate, or a combination thereof.

15. The downhole article of claim 13, wherein the host ions are selected from hydroxide, halide, sulfate, nitrate, or a combination thereof.

16. The downhole article of claim 1, wherein the ion exchange polymer comprises styrene polymer, phenolic polymer, acrylic polymer, methacrylic polymer, polyvinyl alcohol, carbon fiber, polyacrylamide, polyphenylene ether, polysulfone, polyester, fluorinated polymer, cellulose, agarose, dextran, or a combination thereof.

17. The downhole article of claim 16, wherein the ion exchange polymer comprises is a crosslinked product of divinylbenzene.

18. The downhole article of claim 16, wherein the ion exchange polymer comprises a basic functional group, cationic functional group, anionic functional group, or a combination thereof.

19. The downhole article of claim 18, wherein the ion exchange polymer comprises the anionic functional group selected from sulfonic acid group, carboxyl group, phenol group, phosphoric acid group, phosphinic acid group, or a combination thereof.

20. The downhole article of claim 18 wherein the ion exchange polymer comprises polystyrene sulfonic acid, polyacrylic acid, polymaleic acid, poly(vinyl toluene sulfonic acid), poly(styrene sulfonate-co-maleic acid), poly(vinyltoluene sulfonate-co-maleic acid), poly styrene carboxylate, poly(alkylvinyl ether-co-maleic acid), sulfated polyvinyl alcohol, poly(acrylamide-co-2-acrylamido-2-methylpropane carboxylate), poly(styrene-co-acrylamide), poly acrylic acid, poly(styrene carboxylate-co-acrylamide), poly(2-acrylamido-2-methylpropane sulfonate-co-maleic acid), poly(4-styrene sulfonic acid), poly(2-acrylamido-2-methyl-1-propanesulfonic acid), iminodiacetic acid, a salt thereof, derivative thereof, or a combination thereof.

21. The downhole article of claim 18, wherein the ion exchange polymer comprises the basic functional group comprising a primary amino group, secondary amino group, or tertiary amino group; cationic functional group comprising a quaternary ammonium group, quaternary phosphonium, or tertiary sulfonium; or a combination thereof.

22. The downhole article of claim 1 wherein the elastomer comprises acrylonitrile butadiene rubber, ethylene propylene diene monomer rubber, polychloroprene rubber, fluorinated polymer rubber, tetrafluoro ethylene propylene rubber, fluorosilicone rubber, butyl rubber, or a combination thereof.

23. The downhole article of claim 1, wherein the absorbent material comprises polyacrylamide, ethylene maleic anhydride, carboxymethylcellulose, hydroxypropylmethyl cellulose, methylcellulose, polyvinyl alcohol, polyethylene oxide, starch grafted polyacrylonitrile, or a combination thereof.

24. A downhole article comprising:
a composition comprising:
an elastomer; and
an absorbent material; and
an inorganic ion exchange material.

25. The downhole article of claim 24, wherein the inorganic ion exchange material exchanges host ions for fluid ions, the host ions having an ionic charge the same or less positive than that of the fluid ions.

26. The downhole article of claim 25, wherein the inorganic ion exchange material comprises a zeolite, silica, alumina, titania, or a combination thereof.

27. The downhole article of claim 26, wherein the inorganic ion exchange mineral is the zeolite selected from analcime, chabazite, clinoptilolite, heulandite, natrolite, phillipsite, stilbite, Zeolite A, Zeolite B, Zeolite X, Zeolite Y, Zeolite Omega, Zeolite ZSM-5, Zeolite ZSM-4, or a combination thereof.

28. The downhole article of claim 24, wherein the elastomer comprises acrylonitrile butadiene rubber, ethylene propylene diene monomer rubber, polychloroprene rubber, fluorinated polymer rubber, tetrafluoro ethylene propylene rubber, fluorosilicone rubber, butyl rubber, or a combination thereof.

29. The downhole article of claim 24, wherein the absorbent material comprises polyacrylamide, ethylene maleic anhydride, carboxymethylcellulose, hydroxypropylmethyl cellulose, methylcellulose, polyvinyl alcohol, polyethylene oxide, starch polyacrylonitrile, or a combination thereof.

30. A method of manufacturing a downhole article, comprising:
forming a composition comprising an elastomer and an absorbent material;
combining ion exchange particles with the composition to produce a combination; and
shaping the combination to product the downhole article.

31. The method of claim 30, further comprising crosslinking the elastomer.

32. A method of maintaining expandability of a downhole article, comprising:
disposing a downhole article comprising an elastomer, absorbent material, and an ion exchange material in a borehole, the ion exchange material comprising host ions; and
exchanging fluid ions in a fluid with host ions from the ion exchange material to maintain the expandability of the downhole article.

33. The method of claim 32, further comprising binding the fluid ions by the ion exchange material.

34. The method of claim 32, further comprising traversing, by the fluid, the ion exchange material before contacting the absorbent material.

35. The method of claim 32, further comprising sealing the borehole with the downhole article.
